(19) United States
(12) Patent Application Publication
(10) Pub. No.: US 2024/0275860 A1
(43) Pub. Date: Aug. 15, 2024

(54) Management, discovery, registration and communication methods and entities configured to carry out these methods

(71) Applicant: ORANGE, Issy-les-Moulineaux (FR)

(72) Inventors: Michel Trefcon, CHATILLON CEDEX (FR); Philippe Bertin, CHATILLON CEDEX (FR); Alexandra Ansiaux, CHATILLON CEDEX (FR)

(21) Appl. No.: 18/553,362

(22) PCT Filed: Apr. 1, 2022
(86) PCT No.: PCT/FR2022/050616

§ 371 Date: Sep. 29, 2023

(30) Foreign Application Priority Data
Apr. 2, 2021 (FR) 2103445

(51) Int. Cl. H04L 67/56

(52) U.S. Cl. CPC H04L 67/56

(57) ABSTRACT

A method for the management, by a network control entity, of a plurality of application entities offering services in the network. The management method includes: receiving, from a first entity, a bootstrapping request aimed at discovering services offered by the control entity and/or resources managed thereby; and sending a response to the bootstrapping request from the first entity, the response furthermore including at least one encoding format supported by the control entity.

### CROSS-REFERENCE TO RELATED APPLICATIONS

This application is a Section 371 National Stage Application of International Application No. PCT/FR2022/050616, filed Apr. 1, 2022, which is incorporated by reference in its entirety and published as WO 2022/208033 A1 on Oct. 6, 2022, not in English.

### FIELD OF THE DISCLOSURE

The invention belongs to the general field of telecommunications.

It relates more particularly to accessing services offered by application entities of a telecommunications network.

The invention is applied preferably, but without limitation, in the context of 5^{th} generation (or 5G) telecommunications networks defined by the 3GPP (or Third Generation Partnership Project) standard.

### BACKGROUND OF THE DISCLOSURE

5G networks as defined by the 3GPP standard make use, in a manner known per se, of network function virtualization (NFV), software-defined networking (SDN) and network slicing technologies. These technologies are opening up new prospects for the use of telecommunications networks. In particular, they allow operators to create customized, independent, scalable and agile end-to-end virtual logical networks for their clients, using one and the same physical network infrastructure (one or more access networks, core network, etc.). Through these virtual logical networks, operators are capable of providing their clients with optimized solutions for various scenarios corresponding to various constraints in terms of functionality, performance and quality of service.

Network function virtualization or NFV relies on standard servers to run network services software (also called network functions or NF), whereas software-defined networking or SDN centralizes control of the 5G network through software rather than via physical equipment. By virtue of this virtualization, network functions may be easily deployed and reconfigured, thus providing greater elasticity.

Various network functions of a 5G core network may thus be virtualized, such as for example the access mobility management network function (AMF), the session management network function (SMF), the network slice selection network function (NSSF), the policy control network function (PCF), etc. These virtualized functions are controlled in the 5G core network by another network function called a network repository function (NRF). This NRF function is responsible for providing a client or consumer network function with information allowing it to interact, directly or indirectly via an intermediate equipment (or SCP for service communication proxy), with a server network function (“producer”) offering one or more services in the network.

Indeed, the 5G network architecture defined by the 3GPP standard is a service-based architecture (SBA). In such an architecture, the functionalities of a 5G network are provided by a plurality of virtual network functions (or indiscriminately NF functions in the remainder of the description) that provide services to other functions of the network that are authorized to access these services, one and the same network function being able to offer one or more services. To this end, the NF functions of the 5G core network present the services that they offer in the context of the 5G core network (in other words their functionalities) by way of interfaces in the form of APIs (application programming interfaces) that the other authorized NF functions may invoke. However, instead of predefined interfaces between the various NF functions able to interact with one other, a service model is used in which the “consumer” NF functions interrogate the NRF network function in order to discover the “producer” NF functions and communicate therewith on the APIs that they offer. This advantageously offers 5G network operators great flexibility and great adaptability.

The NRF network function is thus a repository that manages a plurality of NF functions, and stores the profiles of each of these NF functions. Each profile comprises a plurality of attributes, characterizing the operational status of the NF function (for example its availability, its load, how long since it was started, etc.), its characteristics (for example NF function type, how it is able to be reached, etc.), the services that it offers, the resources that it manages, etc. Attributes may also be defined more specifically at the level of each service (otherwise, it is those defined at the level of the NF function that apply). These profiles allow “consumer” NF functions to discover the providers of particular services and features in the network.

The NRF network function is updated upon activation and deactivation of each of the NF functions that it manages (that is to say upon registration and deregistration of each of them) as well as upon each resizing of an NF function (indeed, the NRF function is able to manage multiple instances of one and the same NF function). It offers the NF functions of the 5G core network various services described in particular in the 3GPP document TS 29.510 entitled “Technical Specification Group Core Network and Terminals; 5G System; Network Function Repository Services; Stage 3”, v16.6.0, December 2020, namely:
a discovery service (“Nnrf_NFDiscovery” service), allowing a “consumer” NF function to discover the instances of a “producer” NF function offering services that meet its needs;
a management service (“Nnrf_NFManagement” service), performing registration, deregistration and updating operations, and allowing the NRF function to be informed of the available instances of “producer” NF functions and of the services offered by these NF functions;
a service authorization service (“Nnrf_AccessToken” service), for ensuring that a “consumer” NF function is authorized to access the services offered by a “producer” NF function.

The 3GPP standard also defines a subscription procedure via which a “consumer” NF function is able to ask the NRF function to be informed of any change affecting a “producer” NF function (for example, availability of a new instance, update to an attribute of the profile of an NF function, etc.). Release 16 also describes a “Nnrf_Boostrapping” bootstrapping procedure allowing the services offered by an NRF function to be discovered by the NF entities of the 5G core network or by other NRF entities belonging to the same network or to a different (PLMN) network.

FIG. 1, extracted from the document by Joe Wilke entitled “5G Network Architecture and FMC”, IMT-2020/5G Workshop and Demo Day seminar, July 2017, schematically illustrates the service-based interface (API) (or SBI) implemented between two network functions NF A and NF B in a 5G network in accordance with the 3GPP standard. These network functions are in turn “consumer” and “producer” depending on the service under consideration, and exchange with one another using specific methods compliant with the HTTP (Hypertext Transfer Protocol) client-server protocol, based for example on GET, POST, PUT or else PATCH requests and the associated responses, these methods possibly optionally comprising header parameters and specific bodies, and targeting specific resources identified respectively by uniform resource identifiers (URI). These specific elements (resources, HTTP methods, header parameters, body structures in requests or responses) are defined more specifically in the 3GPP documents describing NF functions more specifically.

The resources of the 5G core network cannot be extended indefinitely, in particular with regard to the bandwidth and the capacity of “producer” NF functions (of a fixed number) to process the HTTP requests issued by “consumer” NF functions. Thus, by optimizing the HTTP traffic exchanged between NF functions with a constant bandwidth, the performance of the 5G core network is improved, and more particularly its capacity to absorb traffic as well as its latency.

As mentioned above, the 5G core network uses the HTTP client-server protocol with regard to exchanges between NF functions, and more particularly the HTTP/2 protocol. In a manner known per se, the HTTP/2 protocol is a major evolution of the HTTP/1.1 protocol: it has been designed to reduce latency and make exchanges more secure, while remaining compatible with the HTTP/1.1 version. To this end, it offers new functionalities such as in particular the possibility of multiplexing requests and responses, compressing HTTP headers, or even transmitting data in binary form. It is important to note, however, that the HTTP/2 protocol does not modify the application semantics of the HTTP protocol in any way. All basic concepts of the HTTP protocol, such as methods, status codes, URIs and header fields are preserved. In contrast, the HTTP/2 protocol modifies how data are formatted and transported between a client and a server. By virtue in particular of the compression of the headers of the requests and of the responses, the HTTP/2 protocol makes it possible to reduce and optimize the volume of data transmitted compared to the HTTP/1.1 protocol. It should be noted that the body of the requests and of the responses remains, where applicable, compliant with the HTTP/1.1 protocol. This is described in detail in particular in the IETF document RFC 2616 entitled “Hypertext Transfer Protocol—HTTP/1.1”, June 1999.

In a manner known per se, the HTTP protocol is a protocol that was initially developed for the web. Optimization of the encoding of contents exchanged by way of the HTTP protocol (for example text, images, fonts, etc.), and more particularly the compression of these contents, is a key factor advocated nowadays by web actors to reduce latency and bandwidth consumption, and significantly improve user experience. Since the 5G core network is based on the HTTP protocol, like the web, it is envisaged to apply best practices from the web in this area to exchanges taking place in particular between NF functions within the 5G core network. Indeed, by way of indication, the payload of a profile of an NF function provided in a request addressed when registering an NF function or in a response provided by the NRF function in the discovery mechanism, or else in a notification sent by the NRF function when a profile of an NF function is updated, may easily approach 2 megabytes, which, applied to the numbers of these messages exchanged on the 5G core network, may constitute a significant total load. Moreover, the APIs of the services offered by the NF functions of a 5G core network comprise dozens of operations using POST, PUT or PATCH HTTP requests comprising a body containing content, and this number of operations is constantly increasing. An improvement in the reduction of the size of contents exchanged by a few percent or more through the use of encoding implementing data compression would have a non-negligible impact on network bandwidth and latency for all of these operations.

In accordance with the HTTP/1.1 protocol, in an exchange between a client and a server, the client may indicate in the request that it issues to the server, and more particularly in an “Accept-Encoding” header of the request, the various types of encoding that it supports (for example encoding implementing data compression). The server then returns a response to the client the body of which is compliant with the encoding indications provided by the client. The server for its part indicates, in a “Content-Encoding” header of its response, the type (or format) of encoding (and more particularly of compression) applied to the content served to the client. The negotiation of the encoding, when it is implemented, is therefore at the initiative of the client and concerns only the response sent by the server to the client. The client has no way of knowing, before receiving the response from the server, which encoding format said server supports.

In the context of 5G networks, prior to Release 15.4.0, no encoding negotiation is defined at the level of the API interfaces of the NF functions. In Release 15.4.0, the 3GPP standard introduces general rules for encoding negotiation that are described in particular in the 3GPP document TS 29.500 v15.4.0, June 2019, entitled “Technical Specification Group Core Network and Terminals; 5G System; Technical Realization of Service Based Architecture; Stage 3 (Release 15)”. According to these rules:
a “consumer” NF function may determine the encoding formats supported by a “producer” NF function by sending thereto an OPTIONS request, the encoding formats supported by the “producer” NF function being returned thereto in the response to the OPTIONS request;
a “producer” NF function may return an “Accept-Encoding” header as described above containing the encoding formats that it supports in a response, for example a response to a request comprising a body such as a POST, PUT or PATCH HTTP request.

The “consumer” NF function may then use one of the encoding formats provided by the “producer” NF function to encode the body, where applicable, of its next request addressed to the “producer” NF function.

However, an OPTIONS request has been implemented by the 3GPP standard only for the Nnrf_NFManagement service (which comprises the registration, deregistration and updating operations mentioned above) supported by the NRF network function. Generalizing this solution would involve implementing the OPTIONS request for all of the resources of the various API interfaces of all (currently defined and future) NF functions including HTTP requests able to implement encoding of their content, and more particularly the POST, PUT and PATCH HTTP requests. This would result not only in burdensome maintenance of the specifications of the 5G core network, but also in an increase in the volume of signaling exchanged in the core network (one dedicated transaction for each resource on each API), and having to take into account additional logic for each “consumer” NF function.

The other solution proposed by the 3GPP standard (addition of an “Accept-Encoding” header in a response) is used in Release 16 for services offered by the NSSF (Nnssf_NSSAIAvailability service) and NRF (Nnrf_NFManagement, Nnrf_NFDiscovery, Nnrf_AccessToken services) network functions. However, like the previous solution, generalizing this solution would involve modifying all of the APIs of current and future NF functions of the 5G core network. Moreover, unfortunately, it does not allow a “consumer” function to take into account the encoding formats supported by a “producer” function in the first request addressed by the “consumer” function to the “producer” function (the “Accept-Encoding” header being provided only in response to this first request).

Applying the solutions proposed at present by the 3GPP standard to all NF functions of the 5G core network, and to all services offered by these NF functions, therefore seems difficult to envisage.

### SUMMARY

The invention offers a solution that does not exhibit such drawbacks and is able to be easily applied in particular in the context of a 5G network as defined by the 3GPP standard.

It should however be noted that, although they are introduced with reference to a 5G network, to virtual network functions and to the HTTP/2 protocol, these hypotheses in no way limit the invention, and the invention may be used in other contexts. For example, it may be used in networks other than a 5G network, based on service registration and discovery procedures, such as micro-service architectures deployed in a cloud computing system, or more commonly “cloud”. One example of such an architecture is the Consul mesh service solution offered by Hashicorp.

The invention is also applicable to protocols other than the HTTP/2 protocol, such as another version of the HTTP protocol (HTTP/1.1), or to the SOAP (Simple Object Access Protocol), CORBA (Common Object Request Broker Architecture), gRPC (Remote Procedure Call), QUIC, etc. protocols, or to any other protocol based on the exchange of requests and responses, and supporting encoding of the content of the body of the requests and/or of the responses, typically compression of this content. The invention is generally applicable to any (physical or virtual) application entity offering one or more services in a network and able to implement various encoding types or formats (and the associated decodings) so as to encode (and decode), and in particular compress, contents within the framework of these services. For example, an application entity within the meaning of the invention may be a virtual instance of a network function of a given type.

Moreover, the invention is not limited to encodings for compressing contents, even though it is particularly advantageous in this context for optimizing the performance and the latency of a network, as explained above. It is also possible to envisage other encoding formats, such as for example an invariant encoding format (corresponding to keeping the content identical), base64 encoding, or any reversible transformation carried out for a particular purpose (for example reducing the size of content, obtaining content compatible with most systems, making content more secure, etc.), etc.

More specifically, the invention proposes a method for the management, by a network control entity, of a plurality of application entities offering services in the network, said management method comprising:
a step of receiving, from a first entity, a bootstrapping request aimed at discovering services offered by the control entity and/or resources managed thereby; and
a step of sending a response to said bootstrapping request from said first entity, said response furthermore comprising at least one encoding format supported by the control entity.

In correlation, the invention also targets a network control entity managing a plurality of application entities offering services in the network, said control entity comprising a bootstrapping module configured, in response to what is referred to as a bootstrapping request originating from a first entity and aimed at discovering services offered by the control entity and/or resources managed thereby, to provide this first entity with a response to said bootstrapping request, said response furthermore comprising at least one encoding format supported by the control entity.

An application entity is understood to mean any communicating entity (also called communication entity here) configured to implement determined processing logic, such as for example an entity offering and/or consuming services in a network such as a network function or a network function instance, etc. It should be noted that an application entity may be a network entity (that is to say that has a given functionality in a network), but it may also be a user equipment (UE).

The first entity may be for example another control entity, possibly belonging to a public land mobile network (PLMN) different from the control entity, or an application entity that wishes to access the services offered by the control entity, and in particular the registration, subscription or discovery services offered thereby, etc.

Advantageously, in addition to the services offered by the control entity and the resources managed thereby (for example registration, discovery, notification services, etc.), the response addressed by the control entity to the bootstrapping request that it receives from the first entity contains the encoding formats supported by the control entity. This allows the first entity to use one of these formats as soon as it sends a request to the control entity to access one of the services offered thereby. By way of example, if the first entity is an application entity dependent on the control entity, this allows the application entity, when it registers with the control entity, to use one of the encoding formats supported by the control entity to provide its profile. The exchanges between the application entity and the control entity are therefore optimized.

The invention is easily compatible with Release 16 of the 3GPP standard and in particular with the Nnrf_Boostrapping bootstrapping procedure allowing the services offered by an NRF function to be discovered by the NF entities of the 5G core network or by other NRF entities belonging to the same network or to a different (PLMN) network.

In one particular embodiment, the management method furthermore comprises:
a step of registering each application entity managed by the control entity, comprising storing a profile of said application entity, this profile comprising a plurality of attributes including at least one encoding format supported by said application entity and able to be used when accessing a service offered thereby; and
in response to a request originating from a second entity, a step of providing this second entity, for at least one said application entity managed by the control entity, with at least a portion of the plurality of attributes of the profile of this application entity, said portion comprising said at least one encoding format supported by this application entity.

In correlation, the network control entity furthermore comprises:
a registration module, configured to register each application entity managed by the control entity, said registration module being configured to store, upon registration of an application entity, a profile of this application entity comprising a plurality of attributes including at least one encoding format supported by said application entity and able to be used when accessing a service offered thereby; and
a publication module, activated in response to a request originating from a second entity, and configured to provide this second entity, for at least one said application entity managed by the control entity, with at least a portion of the plurality of attributes of the profile of this application entity, said portion comprising said at least one encoding format supported by this application entity.

The request triggering the publication of all or part of the profile of an application entity managed by the control entity to another entity (second entity within the meaning of the invention) may be in particular a request to discover at least one application entity managed by the control entity satisfying for example at least one determined criterion specified implicitly or explicitly in the discovery request (for example application entities offering a given service, providing a given network function, etc.).

There is no limit attached to the nature of the second entity. It may be for example another application entity, managed by the control entity or by another control entity, another control entity, an intermediate equipment such as an SCP acting for example on behalf of another application entity, or else a network entity at the periphery of the core network, a user equipment, etc. The second entity may or may not belong to the same network as the control entity. In the case of a network implementing slicing, the second entity, the control entity and the application entities may belong to different network slices.

The invention thus proposes to integrate, among the attributes listed in the profile of a “producer” application entity and provided thereby to the control entity that manages it when it registers, the one or more various encoding formats that it supports. This advantageously allows the control entity to be able to publish these one or more encoding formats to “consumer” entities of the network or outside the network, interested in the services provided by the “producer” application entity and that ask for it, and to do so before any exchange between the “consumer” entities and the “producer” application entity. A “consumer” entity may thus apply, starting from the first request that it sends to the “producer” entity in the framework of accessing a service offered thereby, one of the encoding formats supported by the “producer” entity. It should be noted that, in the light of the best practices mentioned above, it is common to support encoding formats implementing data compression. Such encoding formats are for example gzip, compress, deflate. The invention thus makes it possible to optimize all exchanges between the “consumer” entity and the “producer” entity, in particular in terms of bandwidth and latency.

Furthermore, particularly advantageously, the one or more encoding formats thus published may be attributes considered by the “consumer” entity to select a “producer” entity from among several ones offering one and the same service, thereby making it possible to optimize the performance of the network even further.

It may also be a search criterion used by a “consumer” entity when discovering “producer” application entities, for example in addition to or as a replacement for more functional criteria.

In the more specific context of a 5G network as defined by the 3GPP standard, the application entities are for example NF functions, the control entity is an NRF network function, and the second entity is another NF function, another control function (belonging or not belonging to the same network as the control entity) or an intermediate SCP equipment. The solution proposed by the invention advantageously makes it possible to avoid laboriously defining API interfaces and/or burdensome maintenance of the 5G network specifications. Indeed, it requires only updating the attributes listed in the profile of an NF function that are stored by the NRF function and published thereby in discovery procedures (directly or indirectly) targeting the NF function. Since this discovery procedure is implemented before any exchange with the NF function in accordance with the 3GPP standard, it does not lead to any additional logic or any additional message exchange (in contrast to the solution based on sending an OPTIONS request) at the network level. The implementation of the invention therefore fits perfectly into the logic of the 5G core network using an NRF function and into the defined procedures of registering profiles of NF functions with the NRF function, of “producer” NF functions being discovered by “consumer” NF functions, in particular in Releases 15 and 16, or in future Releases incorporating these procedures or similar procedures. This results in ease of implementation of the invention for equipment manufacturers, but also ease of configuration for core network operators. The invention thus offers a general and long-term solution that may be applied to any operation of a service offered by an application entity, and in particular by an existing or future virtual network function in a 5G core network.

In one particular embodiment, the management method furthermore comprises:
a step of receiving a subscription request, originating from a third entity, to receive information regarding at least one event affecting at least one profile stored by the control entity, this subscription indicating at least one encoding format supported by the third entity; and
following detection of an event corresponding to said subscription request, a step of notifying said third entity comprising information relating to said detected event encoded by way of a said encoding format supported by the third entity and indicated in the subscription request.

It should be noted that the second and third entities may be one and the same (physical or software) communicating entity, or may be separate entities. They may belong to the same network or to separate networks. In the same way as for the second entity, the third entity may be an application entity managed by the control entity or by another control entity, another control entity, an SCP equipment, a user equipment, etc. Furthermore, the first entity may or may not be separate from the second and/or third entities.

This embodiment also makes it possible to optimize the transmission of notifications sent asynchronously by the control entity to signal various events affecting the profiles of the application entities that it manages, to the entities that have signaled thereto their interest in these events via a subscription mechanism that is known per se. Such events are for example the creation, the modification or even the deletion of a profile of an application entity.

The invention according to this embodiment advantageously proposes that, upon subscription, the third entity indicates the one or more encoding formats that it supports so that the control entity is able to make use of these encoding formats when it sends notifications thereto. Depending on the event that caused the notification and the configuration of the control entity, such a notification may comprise one or more profiles in full or in part (for example part published by the control entity) or only, where applicable, the profile attributes affected by the event. The application of an encoding format to the information carried by the notifications, given the large number of notifications liable to be sent by a control entity and the volume of data carried by each of them, is therefore particularly advantageous in terms of latency and bandwidth.

It should be noted that this embodiment is advantageous whether or not the third entity of the network is managed by the control entity, in particular in the context of the 3GPP standard. Indeed, the control entity knows, for the application entities that it manages, the services offered by these application entities as “producers” (that is to say as service providers) and the attributes associated with these services (and therefore, according to the invention, the encoding formats supported by these services). However, when a communicating entity subscribes to a notification service for events relating to the profiles managed by the control entity, this entity acts as a “consumer” (that is to say as a consumer of the notification service). Therefore, even though this entity is an application entity registered with the control entity, the control entity does not know the encoding formats supported thereby as “consumer”. The embodiment that has just been described allows the control entity to store this information, for example in the subscription context associated with the entity in question, for use in future notifications, where applicable. Storing this information in the subscription context avoids having to manage and update this information via new processing logic. Indeed, the encoding formats stored in the profile and in the subscription context advantageously inherit pre-existing mechanisms implemented in the network for managing the other attributes contained in the profile and the other subscription information. The invention is therefore particularly simple to implement.

There is no limit attached to the way in which the third entity signals the one or more encoding formats that it supports when subscribing to the control entity. They may for example be indicated in the body of the subscription request with the other subscription information, in a field provided for this purpose.

As will be apparent in the light of the above, the invention is based on the control entity registering and publishing the encoding formats supported by the application entities that it manages, but also on these application entities, which, when they register with the control entity, provide thereto the encoding formats that they support, as well as on the entity that is informed of these encoding formats and is able to make use of them starting from its first exchanges with the application entities.

Thus, according to another aspect, the invention also targets a method for the discovery, by an entity, of services offered and/or resources managed by a network control entity managing a plurality of application entities offering services in the network, said discovery method comprising:
a step of sending a bootstrapping request to said control entity, aimed at discovering services that it offers and/or resources managed thereby;
a step of receiving a response to said bootstrapping request, furthermore comprising at least one encoding format supported by the control entity.

The invention also targets a method for registering an application entity offering at least one service in a network with a network control entity managing a plurality of application entities offering services in the network, said registration method comprising:
a step of discovering the services and/or resources managed by the network control entity using a discovery method according to the invention; and
a step of registering the application entity with the control entity, comprising said application entity providing the control entity with a profile of said application entity, this profile comprising a plurality of attributes including at least one encoding format supported by said application entity and able to be used when accessing a service offered thereby, said control entity being configured to provide at least a portion of said plurality of attributes of the profile of the application entity, said portion comprising said at least one encoding format, in response to a request originating from another entity.

In correlation, the invention also relates to a network application entity offering at least one service in the network, said application entity comprising:
a discovery module, configured to send what is referred to as a bootstrapping request to a network control entity managing a plurality of application entities offering services in the network, said bootstrapping request aiming to discover services offered and/or resources managed by said control entity, said discovery module furthermore being configured to receive a response to said bootstrapping request comprising said services offered and/or resources managed by said control entity and at least one encoding format supported by said control entity; and
a registration module, configured to register said application entity with said network control entity, said registration module being configured to provide the control entity, upon said registration, with a profile of said application entity, this profile comprising a plurality of attributes including at least one encoding format supported by said application entity and able to be used when accessing a service offered thereby, said control entity being configured to provide at least a portion of said plurality of attributes of the profile of the application entity, said portion comprising said at least one encoding format, in response to a request originating from another entity.

In one particular embodiment, a said encoding format supported by the control entity is used upon registration by said application entity to encode the profile provided to the control entity.

According to yet another aspect, the invention targets a method for communication between what is referred to as a “fourth” entity and a network control entity managing a plurality of application entities offering services in the network and storing profiles of these application entities, said communication method comprising:
a step of discovering the services and/or resources managed by the network control entity using a discovery method according to the invention;
a first step of sending, to said control entity, a request to discover application entities managed by the control entity; and
a step of receiving a response to said discovery request indicating at least one what is referred to as candidate application entity managed by the control entity and a plurality of attributes of this candidate application entity extracted from a profile of the application entity stored by the control entity, said plurality of attributes including at least one encoding format supported by this candidate application entity and able to be used when accessing a service offered thereby.

In correlation, the invention also relates to what is referred to as a “fourth” entity comprising:
a first communication module configured to send, to a network control entity managing a plurality of application entities offering services in the network and storing profiles of said application entities, a first request to discover application entities managed by the control entity; and
a reception module, configured to receive a response to said discovery request indicating at least one what is referred to as candidate application entity managed by the control entity and a plurality of attributes of this candidate application entity extracted from a profile of the application entity stored by the control entity, said plurality of attributes including at least one encoding format supported by this candidate application entity and able to be used when accessing a service offered thereby.

In one particular embodiment, the communication method comprises a second step of sending, to a said candidate application entity indicated in the received response, a request comprising content encoded by way of an encoding format supported by this candidate application entity and indicated in the received response.

In correlation, the fourth entity comprises, in this embodiment, a second communication module, configured to send, to a said candidate application entity indicated in the received response, a second request comprising content encoded by way of an encoding format supported by said candidate application entity and indicated in the received response.

It should be noted that the fourth entity may be any one of the first, second and third entities mentioned above or a separate entity. It may, in the same way as the other entities, be an application entity, a control entity, or any other entity such as a network entity or a user equipment.

Thus, by virtue of the invention, the request sent in the second sending step is the first request that the fourth entity sends to the candidate application entity when accessing a service offered thereby.

The fourth entity does not actually need to send an additional request (for example OPTIONS request) to the candidate application entity to ascertain an encoding format supported thereby. It is able, starting from the first request sent to the candidate application entity, to make use of an encoding format that it knows is supported by the candidate application entity to encode content that it sends thereto.

The application entity, the fourth entity, the registration method and the communication method according to the invention have the same advantages mentioned above as the management method and the control entity according to the invention.

In one particular embodiment in which the response to the discovery request indicates a plurality of candidate application entities, the candidate application entity to which the request is sent by the fourth entity in the second sending step is selected from among said plurality of candidate active entities, taking into account the respective encoding formats supported by this plurality of candidate application entities.

In other words, the encoding formats supported by the application entities discovered by the fourth entity (candidate application entities within the meaning of the invention) are used as selection criterion by the fourth entity to select an application entity from among these discovered application entities. The fourth entity may thus favor one application entity out of multiple ones because it supports an encoding format not supported by the others or is more advantageous in terms of optimizing its communications. Of course, this criterion may be combined with other selection criteria, such as for example the service provided by the application entity in question, its function, its availability, etc.

In one particular embodiment, the communication method furthermore comprises
a step of sending a subscription request to the control entity to receive information regarding at least one event affecting at least one profile stored by the control entity, this subscription request indicating at least one encoding format supported by the fourth entity; and
following detection of an event corresponding to said subscription request, a step of receiving a notification originating from the control entity comprising information relating to said event encoded by way of a said encoding format supported by the fourth entity and indicated in the subscription request.

The advantages of this embodiment have already been discussed above for the control entity. An event affecting at least one profile stored by the control entity may be in particular creation, deletion or modification of such a profile.

In one particular embodiment of the invention, at least one said encoding format supported by a said entity (application entity, first, second, third or fourth entity or control entity) aims to encode content transmitted in a body of a request or of a response compliant with a version of the HTTP protocol (Hypertext Transfer Protocol).

Moreover, at least one said encoding format is a data compression format.

The invention is preferably applicable in particular in the context of 5G networks defined by the 3GPP standard to the HTTP/2 protocol, for compressing contents of requests compliant with this protocol and exchanged between the various entities involved in the invention.

However, as mentioned above, the invention may be applied in association with other protocols and other encoding formats.

In one particular embodiment of the invention, in at least one profile of an application entity managed by the control entity, at least one said encoding format is provided in an attribute applicable:
to all services offered by this application entity; or
to a given service or to a given version of a service offered by this application entity; or
to a given resource managed by a service offered by this application entity; or
to a given operation applied to a resource managed by a service offered by this application entity.

This embodiment is applicable to the various methods and entities that are the subject of the invention.

It offers the possibility of defining various levels of granularity for the encoding formats for the contents when the invention is implemented: by type of application entities managed by the control entity, by type of services or by service version offered by an application entity, by type of operations within a service, or else by type of resources managed by the services offered by an application entity. The choice of one or the other of these options depends on the behavior of each application entity, depending on whether it is desired to have homogeneous behavior for all of the services that it offers and the resources managed by these services, or on the contrary whether it is desired to adapt the encoding formats depending on the services (including versions of the services) and/or the resources. The invention offers great flexibility in this regard, which may furthermore differ from one application entity to another, from one service to another, from one resource to another, etc.

In one embodiment, at least one said encoding format supported by a said entity is included in a data structure comprising at least one communication option supported by this entity.

In one particular embodiment of the invention, the management, registration and communication methods are implemented by a computer.

The invention also targets a computer program on a recording medium, this program being able to be implemented in a computer or more generally in a control entity according to the invention and comprising instructions designed to implement a management method as described above.

The invention also targets a computer program on a recording medium, this program being able to be implemented in a computer or more generally in an application entity according to the invention and comprising instructions designed to implement a registration method as described above.

The invention also targets a computer program on a recording medium, this program being able to be implemented in a computer or more generally in a network entity according to the invention and comprising instructions designed to implement a communication method as described above.

Each of these programs may use any programming language, and be in the form of source code, object code, or of intermediate code between source code and object code, such as in a partially compiled form, or in any other desirable form.

The invention also targets a computer-readable information medium or recording medium including computer program instructions, such as mentioned above.

The information medium or recording medium may be any entity or device capable of storing the programs. For example, the medium may include a storage means, such as a ROM, for example a CDROM or a microelectronic circuit ROM, or else a magnetic recording means, for example a hard disk, or a flash memory.

Moreover, the information medium or recording medium may be a transmissible medium such as an electrical or optical signal, which may be routed via an electrical or optical cable, by radio link, by wireless optical link or by other means.

The program according to the invention may in particular be downloaded from a network such as the Internet.

As an alternative, the information medium or recording medium may be an integrated circuit in which a program is incorporated, the circuit being designed to execute or to be used in the execution of the management, registration and communication methods according to the invention.

According to yet another aspect, the invention targets a system comprising:
at least one application entity according to the invention offering at least one service in a network;
a network control entity according to the invention managing said at least one application entity; and
at least one (fourth) entity according to the invention.

The system benefits from the same advantages mentioned above as the management, registration and communication methods, the control entity, the application entity and the fourth entity according to the invention.

It is also possible, in other embodiments, to envisage the management, registration and communication methods, the control entity, the application entity and the fourth entity according to the invention having all or some of the abovementioned features in combination.

### BRIEF DESCRIPTION OF THE DRAWINGS

Other features and advantages of the present invention will emerge from the description given below, with reference to the appended drawings that illustrate one exemplary embodiment thereof that is in no way limiting. In the figures:

FIG. 1, already described, shows the SBI interface, offered by the 3GPP standard, between two network functions NF;

FIG. 2 shows, in its environment, a system of a network according to the invention, in one particular embodiment;

FIG. 3 schematically shows the hardware architecture of a computer able to host any one of the entities according to the invention belonging to the system of FIG. 2;

FIG. 4 illustrates bootstrapping and registration procedures implemented in the system of FIG. 2 and based on steps of the management, registration and communication methods according to the invention, in one particular embodiment;

FIG. 5 illustrates a discovery procedure implemented in the system of FIG. 2 and based on steps of the management, registration and communication methods according to the invention, in one particular embodiment;

FIG. 6 illustrates a subscription procedure implemented in the system of FIG. 2 and based on steps of the management and communication methods according to the invention, in one particular embodiment.

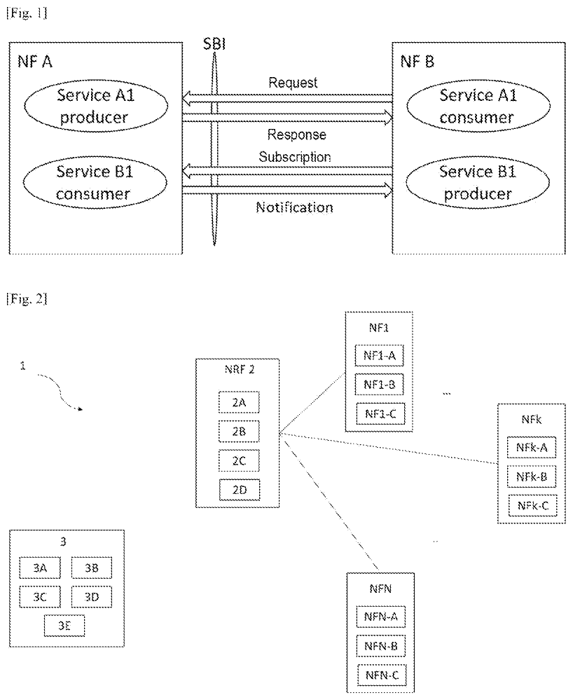

### DESCRIPTION OF THE INVENTION

FIG. 2 shows, in its environment, a system 1 according to the invention, in one particular embodiment in which the system 1 is integrated into a core network CN of a 5G communications network as described in the 3GPP standard.

The system 1 groups together multiple entities of the core network NC, namely:
a plurality of application entities NF1, NF2, . . . , NFN, according to the invention, N denoting an integer greater than 1. An application entity is understood to mean any communicating entity (also called communication entity here) configured to implement determined processing logic, such as for example an entity offering and/or consuming services in a network such as a network function or a network function instance, etc. It should be noted that an application entity may be a network entity (that is to say that has a given functionality in a network), but it may also be a user equipment (UE). In the embodiment described here, each application entity NF1, NF2, . . . , NFN offers one or more services in the network (for example provides one or more determined functionalities of the network). Such application entities (said to be “producers”), in the embodiment described here, are instances of network functions (NF), which are known per se, such as for example instances of AMF, SMF, NSSF, PCF functions, etc. mentioned above. They are virtualized instances, in other words software entities, that run various service logics for providing the main functions of the core network (for example mobility management and core network access, defining and applying network policies, billing, selecting network slices, etc.). Each service offered by an application entity may comprise one or more operations; and
a control entity 2 managing these application entities NF1, NF2, . . . , NFN, according to the invention. In the embodiment described here, the control entity 2 is an NRF network function, in other words a repository storing, for each of the application entities NF1, . . . , NFN, a profile referenced respectively by NF_PROF1, NF_PROF2, . . . , NF_PROFN. Each profile comprises a plurality of attributes, characterizing the operational status of the associated application entity (for example its availability, its load, how long since it was started, etc.), its characteristics (for example NF function type, how it is able to be reached, etc.), the services that it offers, the resources that it manages, etc. The control entity 2 itself offers a plurality of services comprising in particular discovery, management (including the registration/deregistration/update operations) and bootstrapping services, which respectively adopt for example the logic of the Nnrf_NFDiscovery, Nnrf_NFManagement and Nnrf_Boostrapping services described in particular in the 3GPP documents TS 23.502 entitled “Technical Specification Group Services and System Aspects; Procedures for the 5G System (5GS); Stage 2; (Release 16)”, v16.7.0, December 2020, and TS 29.510 entitled “Technical Specification Group Core Network and Terminals; 5G System; Network Function Repository Services; Stage 3”, v16.6.0, December 2020, with the exception of the modifications provided by the invention. This list is not exhaustive per se and is intended only to identify the services of an NRF entity that are impacted by the invention.

In the embodiment described here, the system 1 also comprises at least one other communicating entity 3 according to the invention. There is no limit attached to the nature of this entity. It may be, indiscriminately, another application entity, managed or not managed by the control entity 2 (in other words, the entity 3 may be one of the application entities NF1, . . . , NFN), an intermediate SCP equipment, another NRF control entity belonging or not belonging to the same network as the control entity 2, or any other network entity or else a user equipment, etc. In the embodiment described here, this network CN entity 3 is a core network CN entity that consumes (or is a “consumer” of) one or more services offered by the application entities NF1, . . . , NFN managed by the control entity 2.

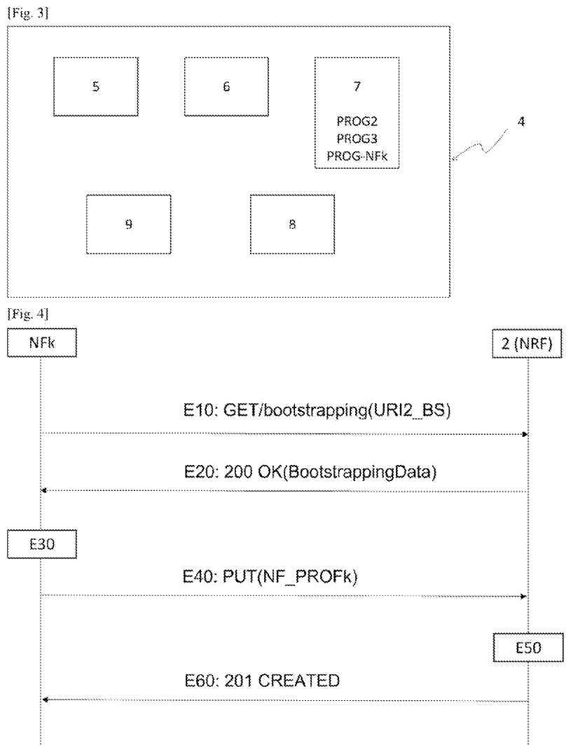

The entities of the system 1 are, in the embodiment described here, software entities, hosted by physical devices of the core network CN, such as servers, for example. These servers here have the hardware architecture of a computer 4, as shown schematically in FIG. 3.

The computer 4 comprises in particular a processor 5, a random access memory 6, a read-only memory 7, a non-volatile memory 8, and communication means 9 allowing in particular the entities of the system 1 to communicate with one another and with other elements, where applicable, of the core network CN or of another network. These communication means 9 are based, on the one hand, on a wired or wireless communication interface, which is known per se and not described in more detail here, but also on one or more service-based software interfaces or SBI. These software interfaces are APIs that use the HTTP/2 protocol here.

The read-only memory 7 of the computer 4 constitutes a recording medium according to the invention, able to be read by the processor 5 and on which one or more computer programs according to the invention is or are recorded.

More specifically, the read-only memory 7 of the computer 4 comprises, when the computer 4 hosts an application entity NFk, k=1, . . . , N according to the invention, a recording of a computer program PROG-NFk, comprising instructions defining the main steps of a registration method according to the invention.

This program PROG-NFk defines functional modules of an application entity NFk, k=1, . . . , N according to the invention that are based on or control the abovementioned hardware elements 5 to 9 of the computer 4. In the embodiment described here, these modules comprise in particular, as illustrated in FIG. 2:
a module NFk-A, configured to offer one or more services (or functionalities) in the network CN by way of an SBI interface, for example to other application entities such as other network functions or else, in the example envisaged here, to the entity 3. The services offered by the module NFk-A of course depend on the type of application entity NFk under consideration. For example, an AMF application entity NFk offers the following services: user equipment registration management, user equipment reachability management, session management, user equipment mobility management, access management (authorization, etc.), etc.;
a discovery module NFk-B for discovering the services offered by the control entity with which the application entity NFk has to register. More particularly, in the example envisaged here of a 3GPP 5G core network, it is assumed that the application entity NFk is configured with a reachability address of the control entity with which it has to register (the control entity 2 here), but that it does not know a priori the services supported by this control entity (for example the NF function management service with which it has to register), nor the resources managed by the control entity 2. To obtain this information, the discovery module NFk-B is configured to send what is known as a bootstrapping request to the control entity 2 whose address it knows, and to obtain a response to this bootstrapping request comprising the services supported by the control entity 2, the resources that it manages, and at least one encoding format that the control entity 2 supports; and
a registration module NFk-C configured to register the application entity NFk with the core network CN control entity 2 that manages it. The registration module NFk-C is configured to provide the control entity 2, upon this registration, with a profile NF_PROFk of the application entity NFk, encoded with one of the encoding formats provided by the control entity 2 in response to the bootstrapping request. The profile NF_PROFk comprises a plurality of attributes characterizing the application entity (for example type, reachability addresses, PMLN, etc.), an identifier of this application entity (identifier of the instance of the corresponding network function), its status (for example registered, not available), etc. For an NF function application entity as in the example envisaged here, such attributes comprise in particular the attributes described in the abovementioned 3GPP document TS 29.510. According to the invention, the profile NF_PROFk furthermore includes, as attribute(s), one or more encoding formats supported by the application entity NFk and able to be used when accessing, via an SBI interface, a service offered thereby to encode the contents of the bodies of the requests and/or of the HTTP/2 responses that are sent thereto. Indeed, according to the invention, these one or more encoding formats form part of the attributes that are published by the control entity 2 in the procedures for discovering the application entities, as explained further below. These encoding formats are chosen from among known encoding formats, such as for example the gzip, compress or deflate compression formats, or else the invariant (“identity”) format indicating the absence of transformation applied to the content. In the example envisaged here, it is assumed that one or more profiles comprise at least one compression-format encoding format.

The functions performed by the modules NFk-A, NFk-B and NFk-C are described in more detail below, with reference to the steps of the registration method according to the invention.

Similarly, the read-only memory 7 of the computer 4 comprises, when the computer 4 hosts the control entity 2 according to the invention, a recording of a computer program PROG2, comprising instructions defining the main steps of a management method according to the invention.

This program PROG2 defines functional modules of the control entity 2 (NRF function in the example envisaged) that are based on or control the abovementioned hardware elements 5 to 9 of the computer 4. In the embodiment described here, these modules comprise in particular, as illustrated in FIG. 2:
a registration module 2A, configured to register each application entity NF1, . . . , NFN managed by the control entity 2. In the example envisaged here, in which the control entity 2 is an NRF network function, the registration module 2A is configured for example to carry out operations of the logic of the Nnrf_NFManagement management service defined by the 3GPP standard, adapted to take into account the invention. The registration module 2A is thus configured in particular to store, upon registration of an application entity NFk, k=1, . . . , N, its profile NF_PROFk as described above, which comprises one or more encoding formats supported by the application entity NFk; and
a publication module 2B, activated in response to a request originating from a communicating entity (for example a discovery request originating from the entity 3), and configured to provide this entity (or equivalently, publish to this entity), for at least one application entity NFk managed by the control entity 2, with at least a portion of the plurality of attributes of the profile NF_PROFk of this application entity. The publication carried out by the publication module 2B here targets application entities satisfying at least one determined criterion (for example type of application entities), which may be indicated in the discovery request. In the example of the NRF function envisaged here, the publication module 2B is more particularly configured to carry out for example the operations of the logic of the Nnrf_NFDiscovery discovery service defined by the 3GPP standard, adapted to take into account the invention: more specifically, the attributes of the profile NF_PROFk that are published, in addition to the attributes indicated in document TS 29.510 cited above, include said at least one encoding format supported by the application entity NFk in question.

In the embodiment described here, the program PROG2 furthermore defines the following functional modules:
a notification module 2C, configured to manage subscription requests from entities (of the core network CN or outside the core network CN) with a view to receiving information regarding events affecting the profiles stored by the control entity 2. Such an event is for example the creation, the modification or the deletion of one or more profiles managed by the control entity 2. In the example of the NRF function envisaged here, the notification module 2C is configured to carry out for example operations of the logic of the Nnrf_NFManagement management service defined by the 3GPP standard, in addition to those already carried out by the module 2A, adapted to take into account the invention. More specifically, according to the invention, when a communicating entity subscribes to a notification service with the control entity 2 in order to be informed about determined events, it provides thereto at least one encoding format that it supports. The notification module 2C is then configured to register, in a context CNT associated with the subscription of the network entity, the one or more events indicated upon subscription along with the one or more encoding formats that are provided thereto, and to apply one of these encoding formats to the notifications that it sends to the communicating entity in question when it detects an event corresponding to the subscription; and
a bootstrapping module 2D, configured here, upon what is called a bootstrapping request from a communicating entity (for example a bootstrapping request sent by the module NFk-B to discover an application entity NFk described above), to provide this communicating entity (in other words publish to this entity) with the services that the control entity 2 offers, along with the resources that it manages. In the example of the NRF function envisaged here, the bootstrapping module 2D is configured to carry out for example operations of the logic of the Nnrf_Bootstrapping bootstrapping service defined by the 3GPP standard, adapted to take into account the invention. More specifically, in response to a bootstrapping request from a communicating entity (for example NF function, NRF function or other network entity or else user equipment, belonging to or attached to the core network CN or to another network), the bootstrapping module 2D is configured to provide, in response to this request and in addition to the information requested therefrom, at least one encoding format that the control entity 2 supports.

The functions performed by the modules 2A to 2D of the control entity 2 are described in more detail below, with reference to the steps of the management method according to the invention.

Finally, the read-only memory 7 of the computer 4 comprises, when the computer 4 hosts the communicating entity 3 according to the invention, a recording of a computer program PROG3, comprising instructions defining the main steps of a communication method according to the invention.

This program PROG3 defines functional modules of the entity 3 that are based on or control the abovementioned hardware elements 5 to 9 of the computer 4. In the embodiment described here, these modules comprise in particular, as illustrated in FIG. 2:
a first communication module 3A, configured to send, to the control entity 2, a request to discover application entities managed thereby. This discovery request, which is intended to be processed by the module 2B of the control entity 2 described above, may contain one or more criteria that the application entities have to satisfy, such as for example a type of application entity, a service provided thereby, an encoding format supported by the application entity, etc. Other criteria may be envisaged in addition or as a variant;
a reception module 3B, configured to receive a response to the discovery request indicating at least one what is referred to as candidate application entity managed by the control entity 2 that meets the one or more required criteria. The response sent by the control entity 2 comprises all or some of the profiles of the candidate application entities, including at least, for each candidate application entity, an encoding format supported thereby;
a selection module 3C, configured, when the response to the discovery request indicates multiple application entities, to select one of them according to one or more determined selection criteria. For example, such a selection criterion may be a given encoding format, but other criteria may be envisaged, such as for example a load or a proposed service;
a second communication module 3D, configured to send, to the selected candidate application entity, a request comprising content encoded by way of an encoding format supported thereby; and
a subscription module 3E, configured to send, to the control entity 2, a subscription request to receive information regarding at least one event affecting at least one profile stored by the control entity 2, for example the profiles of the candidate application entities received by the reception module 3B. According to the invention, the module 3E is configured to indicate to the control entity 2, in its subscription request, at least one encoding format supported by the entity 3. The module 3E is furthermore configured to receive and process, when an event corresponding to the subscription request is detected by the control entity 2, a notification from the control entity 2 comprising information relating to this event and encoded by way of an encoding format supported by the control entity 3 and indicated in the subscription request.

The functions performed by the modules 3A to 3E of the network entity 3 are described in more detail below, with reference to the steps of the communication method according to the invention.

It should be noted that, in the example envisaged here, the entity 3 is a core network CN entity separate from the application entities NF1, . . . , NFN managed by the control entity 2. However, this scenario is not limiting per se, and the entity 3 may be integrated into one of the application entities NF1, . . . , NFN. It may likewise belong to a network separate from the core network CN or from the network NW.

A description will now be given of the main steps of a management method, of a registration method and of a communication method according to the invention as implemented respectively by the control entity 2, by each of the application entities NF1, . . . , NFN managed by the control entity 2, and by the entity 3, in one particular embodiment. These steps are implemented through various procedures that are put in place here in the core network CN, between the application entities, the control entity 2 and the entity 3: bootstrapping procedure, registration procedure, discovery procedure, subscription/notification procedure, which are described in more detail below. FIGS. 4 to 6 illustrate these various procedures and the steps of the methods according to the invention involved therein.

FIG. 4 shows the procedures for bootstrapping and registering an application entity NFk with the control entity 2.

In the embodiment described here, as mentioned above, it is assumed beforehand that each of the application entities NF1, . . . , NFN are attached to the control entity 2 and have been configured with a reachability address (for example URI) thereof.

Before registering with the control entity 2, each application entity NFk, k=1, . . . , N, initiates a procedure for discovering the services offered by the control entity 2 and the resources that it manages. The purpose of this procedure is to allow each application entity NFk to dynamically determine how to access the services offered by the control entity 2, and in particular to identify the resources (for example URIs) to which they should send their requests when accessing these services.

To this end, the application entity NFk sends, by way of its discovery module NFk-B, a bootstrapping request to the control entity 2, to the address with which it has been configured (for example the URI “URI2-BS”), aiming to discover the services offered by the control entity 2 and the resources that it manages (step E10). This bootstrapping request is for example a Get/bootstrapping (URI2-BS) HTTP request as defined in the 3GPP standard, in particular in document TS 29.510.

The control entity 2 responds to this request via its bootstrapping module 2D (step E20). More specifically, the latter provides the required information here in the body of a 200 OK HTTP response, namely the services that the control entity 2 offers (for example the NRF_NFManagement management service, the NRF_NFDiscovery discovery service, and the NRF_AccessToken authorization service) and the URIs for accessing the services and the resources managed by these services. The bootstrapping module 2D supplements this information with one or more encoding formats, referenced by ENCOD-2, supported by the control entity 2. It is assumed here that the set ENCOD-2 comprises one or more encoding formats including at least one compression format, for example gzip. All of the abovementioned information is referenced BootstrappingData in FIG. 4.

It should be noted that the encoding formats ENCOD-2 may be defined at various levels, namely so as to apply to all services offered by the control entity 2 and to all resources that it manages, or differ according to the services offered by the control entity 2, or else according to the resources managed by the control entity 2, or the operations carried out on these resources.

Upon receipt of this 200 OK response, the application entity NFk stores the information BootstrappingData in association with the control entity 2 (E30).

In one variant embodiment, the application entity NFk indicates, in the bootstrapping request sent to the control entity 2, for example in the Accept-Encoding header of the bootstrapping request, at least one encoding format that it supports. The control entity 2 may thereby use one of these encoding formats to encode the information BootstrappingData that it sends to the application entity NFk in response to the bootstrapping request, and indicate, in the Content-Encoding header of the response, the encoding format that it has used.

It should be noted that this procedure for bootstrapping or discovering the services and resources of the control entity 2 may be carried out by entities other than the application entities intended to register therewith. For example, it may be carried out by another control entity, such as another NRF entity belonging or not belonging to the same network (PLMN).

In one variant embodiment, the application entity NFk obtains the encoding formats ENCOD-2 supported by the control entity 2 by sending thereto an OPTIONS request, as described above. The control entity 2 responds to this OPTIONS request by providing, in an OK 200 response, the one or more supported encoding formats in the Accept-Encoding header of the response.

Following this discovery procedure, the application entity NFk may register with the control entity 2, using the information BootstrappingData that it possesses about the NRF_NFManagement management service offered by the control entity 2 and the resource (for example URI) to which to point in order to access this service.

More particularly, the application entity NFk sends, by way of its registration module NFk-C, a registration request (PUT HTTP request in the example envisaged here), in the body of which it provides its profile NF_PROFk (step E40). According to the invention, the profile NF_PROFk is encoded by the module NFk-C by way of an encoding format selected from among the encoding formats ENCOD-2 supported by the control entity 2, for example the gzip compression format. The selected encoding format (for example gzip) is indicated in the Content-Encoding header of the registration request.

The registration request is sent to a URI composed of the URI of the registration service and the URI of the resource associated with the application entity NFk to be registered. The profile NF_PROFk, as detailed above, comprises a plurality of attributes, and in particular, in the example envisaged here, the attributes listed in document TS 29.510 in table 6.1.6.2.2-1 in section 6.1.6.2.2. These attributes comprise in particular, without being exhaustive, the identifier (n/InstanceId) of the application entity NFk (which is an instance of a given network function) to be created, the type (n/Type) of the application entity NFk (that is to say type of the network function here), the status (n/Status) of the application entity, its name (n/InstanceName), the PLMN (p/mnList) to which it is attached, its IPv4 and IPv6 addresses (ipv4Addresses, ipv6Addresses), its priority (priority) relative to other application entities of the same type (that is to say to other instances of the same network function), its capacity (capacity), its load (load), its location (locality), etc. Furthermore, according to the invention, the profile NF_PROFk comprises an attribute containing one or more encoding formats supported by the application entity NFk. It is assumed here that at least one of these encoding formats is a compression format.

There is no limit attached to the structure of the attribute containing the one or more encoding formats supported by the application entity NFk. It may be an attribute dedicated to these encoding formats, named for example ContentEncoding, a reserved proprietary attribute (“vendorspecific extensions” described in document TS 29.500 in paragraph 6.6.3) that network operators may define and use as authorized by the 3GPP standard, or else a more global attribute, named for example capInfo, composed of a data structure more generally targeting the communication options supported by the application entity NFk, including in particular the encoding formats. Other communication options may be specified in addition to the encoding formats, such as for example encryption algorithms supported by the application entity NFk, content formats (for example json, xml, multipart, etc.) supported thereby, etc. It should be noted that it is also possible to associate additional information elements with the encoding formats supported by the application entity NFk, such as for example priorities associated with each supported encoding format.

Moreover, the encoding formats indicated in the profile NF_PROFk may be defined at various levels. In a manner known per se, the attributes of an application entity may be defined in the profile of the application entity at the level of the application entity (they then concern all of the services that it offers and the resources that it manages or that these services manage) or at the level of each service individually. In the embodiment described here, the encoding formats supported by the application entity NFk may be provided in attributes applicable:
to all services offered by this application entity; or
to a given service or to a given service version offered by this application entity; or
to a given resource managed by this application entity or by a service offered by this application entity; or
to a given operation on a resource managed by this application entity or by a service offered by this application entity.

This list is not exhaustive, and other levels of granularity may be envisaged.

Upon receipt of the registration request, the control entity 2 registers the application entity NFk by way of its registration module 2A: it stores its profile NF_PROFk at the URI indicated in the registration request and associates an “available” status with the application entity NFk (step E50).

The control entity 2 confirms the registration of the application entity NFk by sending thereto a 201 Created HTTP response (step E60).

Following this registration, updates may be made to the profile of the application entity NFk (not shown in FIG. 4): for example, the application entity NFk may wish to register modifications of certain attributes of its profile or deregister with the control entity 2. To register modifications, the application entity NFk may either resubmit its entire updated profile NF_PROFk, for example here by way of a new PUT HTTP request, or only the modified attributes, for example here by way of a PATCH HTTP request. In one or the other of the options, the application entity NFk provides the profile NF_PROFk or only the modifications in the body of the request, encoded by way of an encoding format selected from among the encoding formats ENCOD-2 supported by the control entity 2 and indicated in the Content-Encoding header of the request. Upon receipt of these elements, the control entity 2 updates the profile NF_PROFk that it stores, and confirms that the update has been taken into account to the application entity NFk.

As mentioned above, the application entity NFk may also wish to deregister: in this case, it addresses a deregistration request (DELETE HTTP request in the example envisaged here) to the control entity 2 which, upon receipt of this request, associates an “unavailable” status with the application entity NFk. The profile associated with the application entity NFk is also deleted (for example at the end of a determined time interval).

It should be noted that, as described in more detail below, the three events that have just been described, namely the creation of a profile (or, equivalently, the registration of an application entity), its modification or its deletion (or, equivalently, the deregistration of the application entity), may be subject to notifications sent by the control entity 2 to the entities that have subscribed thereto, where applicable, for notification of these events.

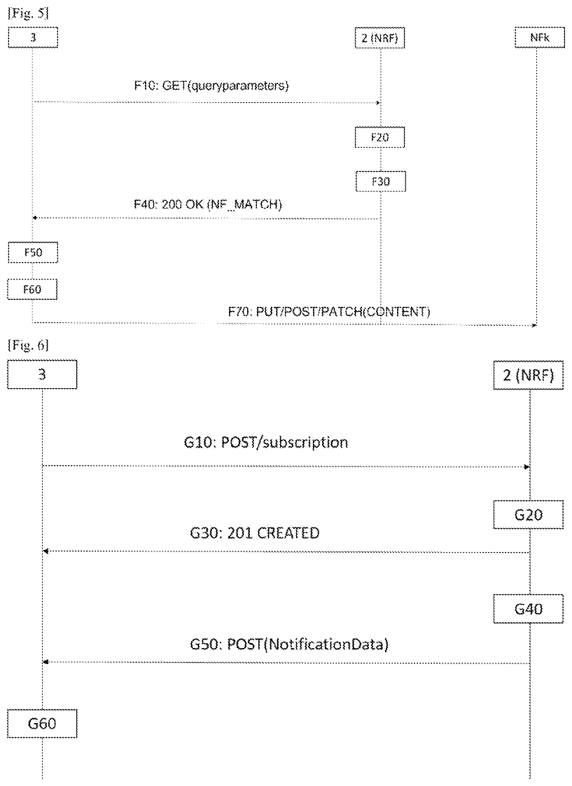

FIG. 5 shows a procedure for the discovery, by the entity 3, of application entities managed by the control entity 2. No assumptions are made regarding the nature of the entity 3. For example, it may be another client application entity (“consumer”) of the services of the application entities managed by the control entity 2.

It is thus assumed for example that the entity 3 wishes to discover all of the application entities managed by the control entity 2 satisfying one or more given search criteria, for example the application entities providing a particular service or corresponding to a determined network function. The invention is not limited to functional search criteria, and it is also possible to envisage, in addition or as a variant, basing this search on other criteria such as for example on a communication option supported by the application entities, and more specifically on a particular encoding format.

The entity 3, by way of its first communication module 3A, addresses a discovery request to the control entity 2 (step F10). This discovery request here is for example a GET HTTP request. It comprises parameters “query parameters” specifying the one or more search criteria set by the entity 3.

Upon receipt of this discovery request, the control entity 2 checks that the entity 3 is authorized to discover the application entities managed by the control entity 2 (step F20). It does this in a manner known to those skilled in the art and not detailed here.

Where applicable, the control entity 2, by way of its publication module 2B, searches for the one or more application entities registered therewith that satisfy the one or more search criteria indicated by the entity 3 (step F30). In the embodiment described here, if multiple search criteria are indicated in the discovery request, the publication module 2B searches for the application entities satisfying each of these criteria. In one variant embodiment, it may search for the application entities satisfying at least one of these criteria.

It is assumed that, at the end of this search, the control entity 2 obtains a set NF-MATCH comprising one or more what are referred to as “candidate” application entities satisfying the search criteria of the entity 3. For the sake of simplicity hereinafter, reference is made to “candidate entities of the set NF-MATCH”, including when this set comprises only one candidate entity.

The control entity 2 then sends the result of its search to the entity 3 in a 200 OK HTTP response (step F40). It indicates, in the body of the response, the candidate application entities NF-MATCH corresponding to the one or more search criteria along with the attributes of these candidate application entities that are useful for the entity 3 for accessing the services offered by these candidate application entities. In the embodiment described here, this involves only some of the attributes present in the profile NF_PROFk: only the attributes needed for the choice and for accessibility of the services are provided to the entity 3 (for example application entity identifier, application entity type, application entity status, encoding formats, etc.). According to the invention, the transmitted attributes include in particular the one or more encoding formats supported by the candidate application entities of the set NF-MATCH.

As a variant, the control entity 2 may provide the entity 3 with all of the attributes listed in the profiles of the candidate application entities of the set NF-MATCH.

In one variant embodiment, the entity 3 indicates, in the Accept-Encoding header of the discovery request addressed to the control entity 2, the encoding formats that it supports (for example at least one compression format), and the control entity 2 encodes the set NF-MATCH and the associated attributes by way of one of these encoding formats (for example the compression format), and indicates the used encoding format in the Content-Encoding header of the response.

In yet another variant, the control entity 2 determines the encoding formats supported by the entity 3 by sending thereto an OPTIONS request and uses one of these encoding formats, as described above.

In the embodiment described here, following the receipt of the response from the control entity 2, the reception module 3B of the entity 3 extracts the information contained in the response and stores it for example in a cache memory for a determined duration (step F50). When it needs to access a particular service corresponding to the one or more search criteria that the candidate application entities of the set NF-MATCH meet, it may thereby quickly access the attributes of these candidate application entities by consulting its cache memory.

It is now assumed that the entity 3 actually wishes to access a service offered by the candidate application entities of the set NF-MATCH.

If the set NF-MATCH comprises multiple candidate application entities, the entity 3 may, by way of its selection module 3D, select one of them according to one or more determined selection criteria (step F60). The selected application entity is denoted NFk0. For example, the selection module 3D may take into account, to select the application entity NFk0 from the set NF-MATCH, the encoding formats supported by the candidate application entities and select one thereof that supports a specific encoding format (for example a compression format such as gzip). As a variant or in addition, other selection criteria may be considered by the selection module 3D, such as for example the loads of the candidate application entities or their respective capacities, or a priority associated with each of them, or their locations, or else a combination of several of these criteria or other criteria.

Following this selection, the entity 3, via its second communication module 3D, sends a request for access to the service offered by the selected application entity NFk0 (step F70). This request is for example here a POST, PUT or PATCH HTTP request, depending on the service under consideration, comprising a request body carrying content. By virtue of the invention, the communication module 3D is advantageously able to encode this content by way of an encoding format supported by the application entity NFk0 according to the information stored in its cache memory in step F50. In other words, the entity 3 is able to make use of an encoding format supported by the application entity NFk0, such as a compression format, starting from the first request that it sends thereto when accessing a service offered by the application entity NFk0. It is not obliged to wait for a response to this first request to encode the contents that it wishes to transmit thereto. Of course, it may (and preferably continues to) apply this encoding format in subsequent requests as well.

It should be noted that, in some contexts, it may prove inappropriate (or even forbidden) to apply a compression format to content sent in the body of a request or of a response. This is the case for example when the content in question comprises a small number of bytes: the compression of such content may then have an effect opposite to that sought, namely that the number of bytes of the compressed content may be greater than that of the uncompressed content. Likewise, certain services offered by certain application entities, such as for example AMF or SMF entities, comprise operations based on requests and/or responses that have bodies composed of multiple parts. A compression of some of these parts does not necessarily provide any significant gain, or is even forbidden. To manage these situations, the entity 3 may be configured to check, before applying an encoding format to the content (in full or in part) of a request or of a response that it sends to an application entity, whether the content is appropriate (for example whether it satisfies a determined size criterion or whether encoding thereof is not forbidden).

As mentioned above, the profile of an application entity managed by the control entity 2 may be affected by various events (for example creation, deletion, modification), and change over time. This may mean that the information stored in the cache memory of the entity 3, and in particular the encoding formats supported by the application entities, may no longer be up-to-date when the entity 3 seeks to access a service offered by one of the candidate application entities, without the latter being informed thereof. In the example of encoding formats, if the event consists of the activation of a new encoding format at the level of a candidate application entity, this does not pose any problem per se provided that the other encoding formats are still supported by the candidate application entity. A problem arises when an encoding format is no longer supported by the candidate application entity.

Multiple solutions are then possible for managing this scenario in the context of the invention.

A first solution, known from the 3GPP standard, consists, if the entity 3 uses an encoding format that is no longer supported by the application entity with which it interacts and receives a rejection response with a 415 status, in sending the request again without encoding or with encoding compliant with one of the formats indicated, where applicable, by the application entity in a header of the 415 response, for example in an Accept-Encoding field.

A second option, also known from the 3GPP standard, consists, following receipt of the 415 rejection response, in sending an OPTIONS request to the application entity in order to obtain an update to the encoding formats that it supports.

The choice of one or the other of these options depends on the configuration of the network entity 3 (implementation choice made by the equipment manufacturer of the entity 3). However, it should be noted that these two solutions may slightly degrade the performance of the entity 3.

According to a third option illustrated in FIG. 6, the entity 3 may subscribe to the control entity 2 to receive notifications informing it about events that affect the profiles of the application entities that it manages. Upon subscription, the entity 3 may specify the extent of the information that it wishes to receive, and in particular the type of events (for example creation, modification, deletion of a profile) about which it wishes to be informed, and the resources in question.

More precisely, in the embodiment described here, the entity 3 sends, by way of its subscription module 3E, a subscription request to the control entity 2 indicating the events about which it wishes to be informed (step G10). These may be for example changes (creation, modification and deletion) affecting profiles of a given application entity type (for example AMF network function). Of course, this example is given only by way of illustration and is not limiting per se. In particular, other elements may be indicated upon subscription, such as for example a particular service, an identifier of an application entity, etc.

The subscription request here is for example a POST HTTP request. It contains the events to which the entity 3 subscribes. It furthermore advantageously contains at least one encoding format supported by the entity 3, for example a compression format.

Upon receipt of the subscription request, the control entity 2 stores, via its notification module 2C, in a context of the subscription of the entity 3, the one or more encoding formats supported thereby (step G20), and confirms the subscription to the entity 3 by sending thereto a 201 Created response (step G30).

Next, when it detects an event corresponding to the subscription of the entity 3 (step G40), the control entity 2, by way of its notification module 2D, sends a notification to the entity 3 to inform it of the detected event (step G50). This notification here is for example a POST HTTP request. It comprises, in the body of the request, the information NotificationData relating to the detected event. This information may comprise, depending on the detected event, all or part of the profile affected by the event (at the very least the part published by the control entity 2 in the discovery procedure). Thus, by way of example, if the event is a profile creation, the notification comprises all of the attributes of the new profile that are usually published in the discovery procedure and that allow the entity 3 to access the service associated with this profile. If the event is a modification of an existing profile, the notification may comprise only the modified attributes, or summarize the set of attributes usually published in the discovery procedure. Advantageously, the information included in the body of the notification is encoded by the notification module 2D in an encoding format supported by the entity 3 and provided upon subscription thereof.

Upon receipt of this notification, the entity 3 updates the profiles in question stored in its cache memory (step G60).

This solution advantageously makes it possible to reduce the time interval during which the entity 3 is liable to use information that is not up-to-date to access the services offered by the application entities NF1, . . . , NFN.

It should be noted that it is possible, at the level of a network entity, to implement several of the three solutions proposed above (for example the first and third solutions) in a complementary manner.

Thus, as will be apparent in the light of the above, the invention makes it possible, in a simple manner, to optimize the exchanges between the various entities of the system 1, based on knowledge of the encoding formats supported by these various entities. It should be noted that, in all of the procedures that have just been described, these encoding formats may be provided indiscriminately in dedicated fields or attributes, in proprietary fields or attributes, or else in data structures such as the capInfo data structure mentioned above, comprising at least one communication option (that is to say at least one encoding format) supported by the entity under consideration.

Although the invention has been described in the context of a 5G network defined by the 3GPP standard, with reference to a network function communicating entity 3 and application entities, and an NRF control entity, as mentioned above, the invention may be applied to other entities. For example, the entity 3 may, as a variant, be another NRF control entity, belonging or not belonging to the same PLMN as the control entity 2, or an intermediate SCP equipment acting on behalf of a “customer” application entity, or else a user equipment attached to the network or an application function located in the network or outside the network. In the case of an SCP equipment, after having discovered the candidate application entities and selecting one of them, the SCP equipment may encode the contents received from the “customer” application entity on whose behalf it acts, using an encoding format supported by the candidate application entity. In other words, the invention makes it possible to implement encoding on the section connecting the SCP equipment to the control entity 2; on the other hand, this does not ensure the implementation of such encoding between the “consumer” application entity and the SCP equipment acting on behalf of this application entity. It should be noted that the SCP equipment is an application entity that may also register with the control entity 2 and be discovered by other entities of the network, and in particular other SCP equipments, assuming that multiple SCPs are located on a path connecting a “consumer” application entity and a “producer” application entity. This also makes it possible to apply encoding to each segment of the communication path connecting two SCP equipments.

Likewise, reference has been made above, in order to better illustrate the invention, to the NRF_Bootstrapping, NRF_NFManagement and NRF_NFDiscovery procedures defined by the 3GPP standard, but the invention may be applied to other procedures aimed at a similar purpose, and in particular to proprietary registration or discovery procedures.

The invention may also be applied in other generations of communications network or in contexts other than a 5G network, such as for example to a 6G network or a subsequent-generation network, to a cloud computing system offering microservices, to a proprietary network, etc. using procedures for registering and discovering these microservices. It may also be applied to other protocols. The invention may furthermore also be applied to application entities other than virtualized network function instances, such as for example physical application entities.

The invention may also be applied to protocols other than the HTTP/2 protocol, such as for example to another version of the HTTP protocol (HTTP/1.1), or to the SOAP, CORBA, gRPC or QUIC protocols, or generally to any other protocol based on the exchange of requests and responses, and supporting encoding of the content of the body of the requests and/or of the responses, typically compression of this content. What has just been described in the context of HTTP/2 requests/responses, and in particular the data conveyed by these requests/responses in order to implement the invention, is applicable in a manner transposed to the requests/responses of these protocols.

Although the present disclosure has been described with reference to one or more examples, workers skilled in the art will recognize that changes may be made in form and detail without departing from the scope of the disclosure and/or the appended claims.

1. A management method for managing, by a network control entity, a plurality of application entities offering services in the network, said management method comprising:
receiving, from a first entity, a bootstrapping request aimed at discovering services offered by the control entity and/or resources managed thereby; and
sending a response to said bootstrapping request from said first entity, said response furthermore comprising at least one encoding format supported by the control entity.

2. The management method as claimed in claim 1, furthermore comprising:
registering each application entity managed by the control entity, comprising storing a profile of said application entity, this profile comprising a plurality of attributes including at least one encoding format supported by said application entity and able to be used when accessing a service offered thereby; and
in response to a request originating from a second entity, providing this second entity, for at least one said application entity managed by the control entity, with at least a portion of the plurality of attributes of the profile of this application entity, said portion comprising said at least one encoding format supported by this application entity.

3. The management method as claimed in claim 2, wherein said request is a request to discover at least one said application entity managed by the control entity.

4. The management method as claimed in claim 1, furthermore comprising:
receiving a subscription request, originating from a third entity, to receive information regarding at least one event affecting at least one profile stored by the control entity, this subscription request indicating at least one encoding format supported by the third entity;
following detection of an event corresponding to said subscription request, a-step notifying said third entity comprising information relating to said detected event encoded by way of a said encoding format supported by the third entity and indicated in said subscription request.

5. The management method as claimed in claim 4, wherein said event comprises modification, deletion or creation of a profile of an application entity managed by the control entity, and/or said information contained in the notification comprises all or part of said profile.

6. A method comprising:
discovering, by a first entity, services offered and/or resources managed by a network control entity managing a plurality of application entities offering services in the network, said discovering comprising:
sending a bootstrapping request to said control entity, aimed at discovering services that said control entity offers and/or resources managed thereby; and
receiving a response to said bootstrapping request, furthermore comprising at least one encoding format supported by the control entity.

7. The method as claimed in claim 6, furthermore comprising:
registering an application entity of the plurality of application entities, said registering comprising:
performing the discovering of the services and/or resources managed by the network control entity; and
registering the application entity with the control entity, comprising said application entity providing the control entity with a profile of said application entity, this profile comprising a plurality of attributes including at least one encoding format supported by said application entity and able to be used when accessing a service offered thereby, said control entity being configured to provide at least a portion of said plurality of attributes of the profile of the application entity, said portion comprising said at least one encoding format, in response to a request originating from another entity.

8. The method as claimed in claim 6, furthermore comprising:
communicating between a fourth entity and the network control entity, the network control entity managing the plurality of application entities offering services in the network and storing profiles of these application entities, said communicating comprising:
performing the discovering of the services and/or resources managed by the network control entity;
sending, to said control entity, a discovery request to discover application entities managed by the control entity; and
receiving a response to said discovery request indicating at least one candidate application entity managed by the control entity and a plurality of attributes of this candidate application entity extracted from a profile of the application entity stored by the control entity, said plurality of attributes including at least one encoding format supported by this candidate application entity and able to be used when accessing a service offered thereby.

9. The method as claimed in claim 8, furthermore comprising a sending, to said at least one candidate application entity indicated in the received response, a content request comprising content encoded by way of an encoding format supported by this candidate application entity and indicated in the received response.

10. The method as claimed in claim 8, wherein the content request sent is the first request that the fourth entity sends to the candidate application entity when accessing a service offered by this candidate application entity.

11. The method as claimed in claim 8, wherein the response to the discovery request indicates a plurality of candidate application entities and the candidate application entity to which the content request is sent is selected from among said plurality of candidate active entities taking into account the respective encoding formats supported by this plurality of candidate application entities.

12. The method as claimed in claim 8, furthermore comprising:
sending a subscription request to the control entity to receive information regarding at least one event affecting at least one profile stored by the control entity, this subscription request indicating at least one encoding format supported by the fourth entity; and
following detection of an event corresponding to said subscription request, receiving a notification originating from the control entity comprising information relating to said event encoded by way of a said encoding format supported by the fourth entity and indicated in the subscription request.

13. The method as claimed in claim 1, wherein at least one said encoding format aims to encode content transmitted in a body of a request or of a response compliant with a version of the Hypertext Transfer Protocol (HTTP).

14. The method as claimed in claim 2, wherein, in at least one profile of an application entity managed by the control entity, at least one said encoding format is provided in an attribute applicable:
to all services offered by this application entity; or
to a given service or to a given version of a service offered by this application entity; or
to a given resource managed by a service offered by this application entity; or
to a given operation on a resource managed by a service offered by this application entity.

15. The method as claimed in claim 1, wherein at least one said encoding format is a data compression format.

16. The method as claimed in claim 1, wherein at least one said encoding format supported by a said entity is included in a data structure comprising at least one communications option supported by this entity.

17. A network control entity managing a plurality of application entities offering services in a network, said control entity comprising:
at least one processor; and
at least one non-transitory computer readable medium comprising instructions stored thereon which when executed by the at least one processor configure the network control entity to manage the plurality of application entities by:
receiving a bootstrapping request originating from a first entity and aimed at discovering services offered by the control entity and/or resources managed thereby-; and
in response to receiving the bootstrapping request, providing the first entity with a response to said bootstrapping request, said response furthermore comprising at least one encoding format supported by the control entity.

18. A network application entity offering at least one service in a network, said application entity comprising:
at least one processor; and
at least one non-transitory computer readable medium comprising instructions stored thereon which when executed by the at least one processor configure the network application entity to implement a method comprising:
sending a bootstrapping request to a network control entity managing a plurality of application entities offering services in the network, said bootstrapping request aiming to discover services offered and/or resources managed by said control entity;
receiving a response to said bootstrapping request comprising said services offered and/or resources managed by said control entity and at least one encoding format supported by said control entity; and
registering said application entity with said network control entity, said registering providing the control entity, upon said registration, with a profile of said application entity, this profile comprising a plurality of attributes including at least one encoding format supported by said application entity and able to be used when accessing a service offered thereby, said control entity being configured to provide at least a portion of said plurality of attributes of the profile of the application entity, said portion comprising said at least one encoding format, in response to a request originating from another entity.

19. (canceled)
